(19) United States
(12) Patent Application Publication
(10) Pub. No.: US 2025/0074517 A1
(43) Pub. Date: Mar. 6, 2025

(54) REAR TIRE HITCH RECEIVER

(71) Applicant: Marcus R. Hanna, South Hamilton, MA (US)

(72) Inventor: Marcus R. Hanna, South Hamilton, MA (US)

(21) Appl. No.: 18/819,045

(22) Filed: Aug. 29, 2024

Related U.S. Application Data
(60) Provisional application No. 63/580,256, filed on Sep. 1, 2023.

(51) Int. Cl. B62D 43/02; B60D 1/58; B60R 9/06

(52) U.S. Cl. CPC B62D 43/02; B60D 1/58; B60R 9/06

(57) ABSTRACT

A rear tire hitch receiver is mountable to the hub of a vehicle's rear-mounted tire, and it is configured to receive a hitch-mounted bicycle carrier, cargo rack, or other similarly mounted implement to the rear of the vehicle. The tire-mounted configuration permits a user to conveniently open a vehicle's rear door without removing the hitch-mounted implement, and it does not interfere with the vehicle's rear-view camera. The rear tire hitch receiver includes a yoke and an optional bolt mounting ring to secure the rear tire hitch receiver to a wheel mounted on the rear of a vehicle, and it further includes a wheel bumper to provide an additional secured point of contact against a wheel and an optional tire strap to secure the rear tire hitch receiver around the rear-mounted wheel.

### FIELD OF THE INVENTION

The present application claims the priority of U.S. Provisional Patent Application Ser. No. 63/580,256 filed Sep. 1, 2023, entitled “REAR TIRE HITCH RECEIVER”, and which is incorporated herein in its entirety.

### FIELD OF THE INVENTION

This invention relates to a hitch receiver, and more specifically, for a hitch receiver that is adaptably mounted to a spare tire located externally on the rear of a vehicle. The rear tire hitch receiver is configured to receive a hitch-mounted bicycle carrier, cargo rack, or other similarly mounted implement to the rear of the vehicle.

### BACKGROUND OF THE INVENTION

Hitch receivers are widely used for mounting of numerous hitch-mounted vehicle accessories, including bicycle carriers, cargo carriers, cargo boxes, flag poles, and other vehicle accessories.

Many vehicles do not include a hitch receiver as a standardly-available option, and the process for adding a hitch receiver to an existing vehicle's frame can be expensive, complicated, and can lead to additional problems, noted below.

For cargo-carrying solutions that are mounted directly to an external, rear-mounted spare tire, these products are mounted through the middle of the tire rim or are attached via tension onto the top of the tire tread and strapped to the wheel with fabric webbing. Other temporary solutions include straps attached to a rear window, rear door, or rear-mounted spare tire, but such solutions are unstable and can often block a vehicle's rear-view camera. Similarly, such solutions often lack durability and are not suitable for long-term use, particularly in harsh weather or environmental conditions, where fabric straps may deteriorate or break with time and repeated usage.

For vehicles including a permanent hitch receiver mounted to the vehicle's frame and/or located vertically beneath the vehicle's rear door, an accessory mounted to such a permanent hitch receiver may prevent the vehicle's rear door from being opened. For example, where a bicycle carrier is mounted to a vehicle's permanent hitch receiver, the bicycle carrier may extend vertically upward and be positioned adjacent to the vehicle's rear door, thus preventing the rear door from being opened.

Additionally, several hitch-mounted racks are equipped with a hinge mechanism, permitting the rack to pivot/swing away from the vehicle's rear door and thus allowing the vehicle's rear door to be opened. Such solutions are often difficult to operate, where a user must perform a multi-step process of pivoting the rack and then opening the door. This cumbersome process does not permit quick and easy access to the rear of a vehicle, and similarly, such solutions may have a limited range of pivoting, prohibiting the vehicle rear door from being fully opened. Similarly, these solutions typically extend a considerable distance outward from a vehicle's rear, rendering it difficult for a user to parallel park or otherwise park their vehicle in a small parking area.

In particular, the JEEP® brand vehicles are particularly unsuited for existing solutions, where such solutions do not permit opening of the vehicles rear door that swings outward around a pivot hinge located towards the side of the vehicle (as opposed to a pivot hinge located near the roof of the vehicle). Similarly, such solutions block a JEEP® vehicle's rear-view camera, which is mounted in the center of the rear tire's hub.

Therefore, there exists a need for a hitch receiver that can be removably mounted to the external rear-mounted spare tire, thus permitting a variety of cargo racks to be mounted on a vehicle while allowing the convenient opening and closing of the vehicle rear door and allowing a full range of view for a vehicle's rear-view camera.

### SUMMARY OF THE INVENTION

In accordance with one form of the invention, there is provided a rear tire hitch receiver. In one embodiment, the rear tire hitch receiver includes a stem having a yoke and a bolt mounting ring with lug nut apertures configured for receipt of a plurality of lug nuts, wherein the lug nuts may be removably attached to at least one lug nut receiver of a wheel hub. The stem further includes a wheel bumper configured to contact a wheel when the rear tire hitch receiver is removably attached to the wheel hub. The stem further includes a receiver bracket configured to removably couple a receiver to the stem, wherein the receiver is sized and configured to receive and selectively secure a hitch implement to the rear tire hitch receiver. The receiver further includes a hitch pin aperture for secured receipt of a hitch pin. The receiver further includes a strap guide and a strap attached to the receiver, wherein the strap is sized and configured to be secured around the circumference of the wheel when the rear tire hitch is removably attached to the wheel hub.

### BRIEF DESCRIPTION OF THE DRAWINGS

For a fuller understanding of the nature of the present invention, reference should be made to the following detailed description, taken in conjunction with the accompanying drawings in which:

FIG. 1 is a front perspective view of a rear tire hitch receiver, according to one embodiment;

FIG. 2 is a side view of a rear tire hitch receiver, according to one embodiment;

FIG. 3 is a rear view of a rear tire hitch receiver, according to one embodiment;

FIG. 4 is a front perspective view of a rear tire hitch receiver mounted on a rear tire and hub, according to one embodiment;

FIG. 5 is a side view of a rear tire hitch receiver mounted on a rear tire and hub, according to one embodiment; and

FIG. 6 is a front view of a rear tire hitch receiver mounted on a rear tire and hub, according to one embodiment.

Like reference numerals refer to like reference parts throughout the several views of the drawings.

### DETAILED DESCRIPTION

Referring to the several views of the drawings, the rear tire hitch receiver 100 is shown and described herein.

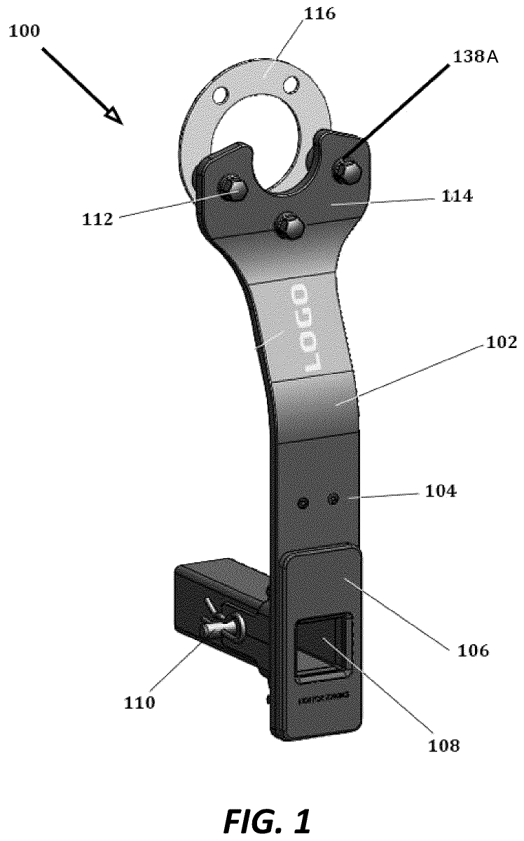

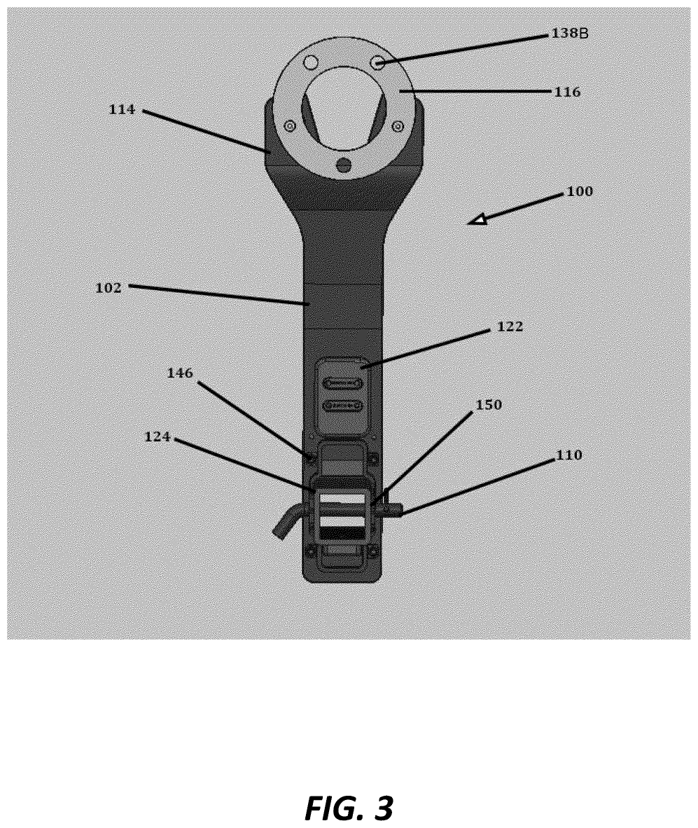

Referring initially to FIGS. 1-3, and according to one embodiment, the rear tire hitch receiver 100 includes a stem 102 having a yoke 114 located at the upper end of the stem 102. The yoke 114 includes a plurality of lug nut apertures 138A, wherein each lug nut aperture 138A is sized and configured for engaged receipt of a lug nut 112, which may be a standard-sized lug nut 112 used in the automotive industry. The yoke 114 may also be attached to a bolt mounting ring 116, wherein the bolt mounting ring 116 includes a plurality of lug nut apertures 138B with each lug nut aperture 138B being sized and configured for engaged receipt of a lug nut 112. The yoke 114 may be attached to a bolt mounting ring 116 via permanent connection or removably via at least one lug nut 112.

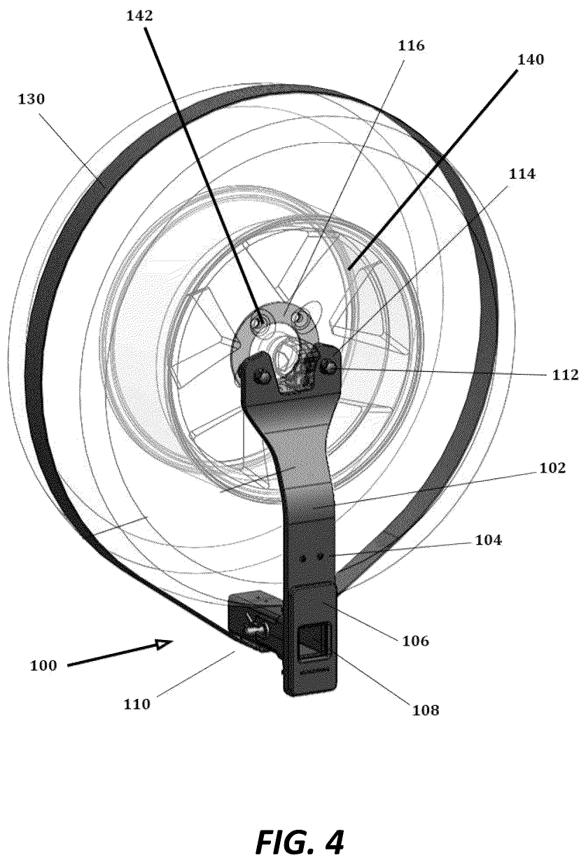

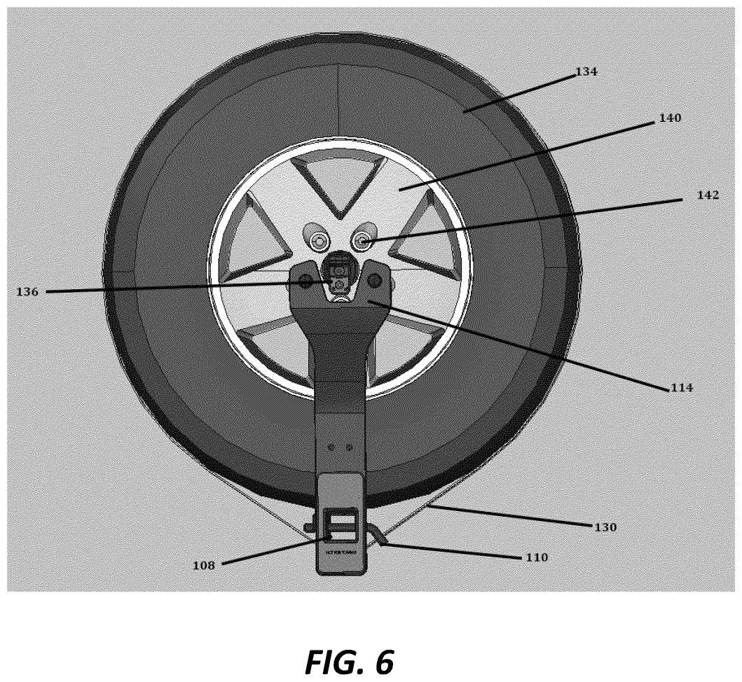

When the rear tire hitch receiver 100 is mounted on a wheel 134, a plurality of lug nuts 112 may be individually inserted through at least one of the corresponding plurality of lug nut apertures 138A and 138B on the yoke 114 and/or bolt mounting ring 116, and the lug nuts 112 may then be threaded into the corresponding lug nut receivers 142 on the hub 140 of the wheel 134 (as shown in FIGS. 4-6). The threaded engagement of the lug nuts 112 into the corresponding lug nut receivers 142 of the hub 142 functions to secure the rear tire hitch receiver 100 to the wheel 134.

It will be appreciated by one of ordinary skill in the art that the bolt mounting ring 116 may be an optional component of the rear tire hitch receiver 100, according to alternative embodiments. Specifically, the lug nuts 112 inserted through the lug nut apertures 138 of the yoke 114 may be utilized for attachment directly to the wheel's 134 hub 140 via the lug nut receivers 142.

The yoke 114 attaches to or is integrated with the stem 102 of the rear tire hitch receiver 100. A receiver 108 is mounted to or integrated with the stem 102, whereby the stem 102 is of sufficient length to permit the receiver 108 and receiver tube 124 to be positioned in proximity to the external edge of a wheel 134 when the rear tire hitch cover 100 is installed on a vehicle. The receiver 108 may have an elongated receiver tube 124 that is sized and configured to receive a hitch-mounted implement. It will be appreciated by one of ordinary skill in the art that according to various embodiments, the stem 102 may be manufactured at various lengths to permit usage with a variety of wheel 134 sizes. Alternatively, the stem 102 may be adjustable or modular to permit usage with a variety of wheel 134 sizes.

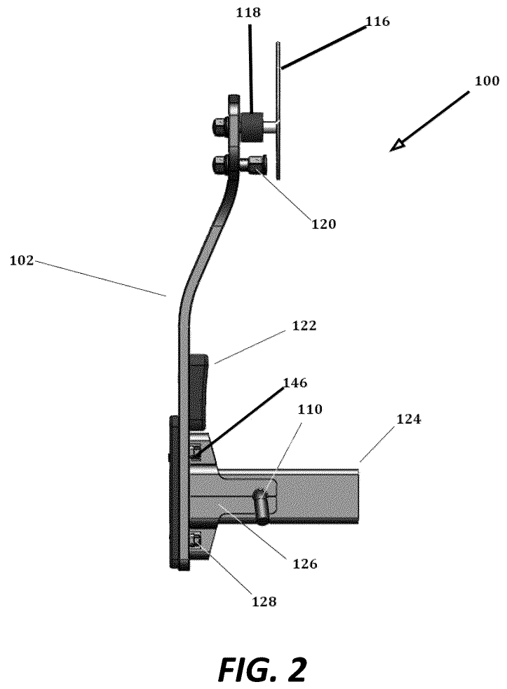

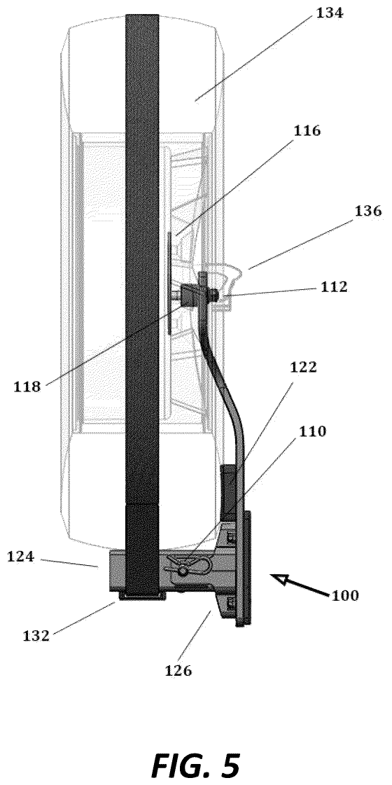

As shown in FIGS. 2 and 5, the rear tire hitch receiver 100 may utilize one or more bolt spacers 118 to secure the yoke 114 to the bolt mounting ring 116, or similarly, to secure the yoke 114 and/or bolt mounting ring 116 to the hub 140 of a wheel 134 where the bolt spacer 118 provides a continuous point of contact between the yoke 114 and the bolt mounting ring 116 or between the yoke 114 and the hub 140.

It will be appreciated by one of ordinary skill in the art that the yoke 114 may include different numbers and configurations of lug nut apertures 138 to adapt the rear tire hitch receiver 100 to different vehicles and wheels 134.

Similarly, the rear tire hitch receiver 100 may utilize one or more bolt extenders 120 to secure the yoke 114 to the bolt mounting ring 116, or similarly, to secure the yoke 114 and/or bolt mounting ring 116 to the hub 140 of a wheel 134 where the gap between the yoke 114 and/or bolt mounting ring 116 is larger than a standard bolt.

A wheel bumper 122 may be attached to a lower end of the stem 102 via bumper mounting screws 104 or via a similar attachment means, whereby the wheel bumper 122 may be of varying sizes and thicknesses to permit sufficient contact with the wheel 134 when the rear tire hitch receiver 100 is secured to a vehicle. The wheel bumper 122 may be in contact with the outside wheel well of the wheel 134 when the rear tire hitch receiver 100 is mounted on a vehicle. The contact between the wheel bumper 122 and wheel 134 (as shown, for example, in FIG. 5) provides an additional support point along the length of the stem 102, and it further serves to reduce vibration along the stem 102 when the vehicle is in motion. According to an alternative embodiment, the wheel bumper 122 may be integrated with or permanently attached to the stem 102. The wheel bumper may be composed of plastic, rubber, or other similar materials.

The lower terminal end of the stem 102 may include a receiver bracket 126 and receiver mounting flanges 128, wherein the receiver bracket 126 is sized and configured for receipt and securement of a receiver tube 124.

A receiver 108 and receiver tube 124 are located on the lower terminal end of the stem 102 and may be attached to the stem 102 via receiver mounting bolts 146 inserted through the stem's 102 receiving mounting flanges 128. The receiver 108 is sized and configured for receipt of a standard hitch for the attachment of, for example, a bicycle rack, cargo rack, cargo box, or other similar hitch-mounted implement. The receiver tube 124 includes a hitch pin 110 that may be inserted through hitch pin apertures 148 into corresponding apertures in the hitch-mounted implement of a component inserted into the receiver tube 124.

A bracket fastener cover 106 may be seated around the receiver 108 and functions to protect and cover the receiver mounting flanges 128, receiving mounting flanges 128, and the receiver mounting bolts 146. The bracket fastener cover 106 may prevent moisture, dirt, or other materials from entering the receiving mounting flanges 128 and may otherwise provide protective cover around the receiver 108.

Referring now to FIGS. 4-6, and according to one embodiment, the receiver tube 124 may include a strap guide 134 for receipt of a tire strap 130, wherein the tire strap 130 may extend and be tightened around the circumference of a wheel 134, with both ends of the tire strap 130 secured at the strap guide 134. The tire strap 130 functions to further secure the rear tire hitch receiver 100 to a wheel 134 and to reduce vibration of the rear tire hitch receiver 100 when the rear tire hitch 100 is mounted on a vehicle. The tire strap 130 may be composed of nylon, polyester, polypropylene, natural fibers, a combination of these materials or of similar, alternative materials.

It will be appreciated by one of ordinary skill in the art that the tire strap 130 may be sized and configured for alternative securement to a wheel 134, whereby, for example, the tire strap 130 may be threaded around and/or through the wheel's 134 hub 140.

While the present invention has been shown and described in accordance with several preferred and practical embodiments, it is recognized that departures from the instant disclosure are contemplated within the spirit and scope of the present invention.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. For brevity and/or clarity, well-known functions or constructions may not be described in detail herein.

The term “exemplary” is used herein to mean serving as an example, instance, or illustration. Any aspect or design described herein as “exemplary” is not necessarily to be construed as preferred or advantageous over other aspects or designs. Similarly, examples are provided herein solely for purposes of clarity and understanding and are not meant to limit the subject innovation or portion thereof in any manner.

The terms “for example” and “such as” mean “by way of example and not of limitation.” The subject matter described herein is provided by way of illustration for the purposes of teaching, suggesting, and describing, and not limiting or restricting. Combinations and alternatives to the illustrated embodiments are contemplated, described herein, and set forth in the claims.

For convenience of discussion herein, when there is more than one of a component, that component may be referred to herein either collectively or singularly by the singular reference numeral unless expressly stated otherwise or the context clearly indicates otherwise. For example, components N (plural) or component N (singular) may be used unless a specific component is intended. Also, the singular forms “a,” “an,” and “the” are intended to include the plural forms as well, unless expressly stated otherwise or the context indicates otherwise.

It will be further understood that the terms “includes,” “comprises,” “including,” and/or “comprising” specify the presence of stated features, steps, operations, elements, and/or components, but do not preclude the presence or addition of one or more other features, steps, operations, elements, components, and/or groups thereof unless explicitly stated otherwise or the context clearly requires otherwise. The terms “includes,” “has” or “having” or variations in form thereof are intended to be inclusive in a manner similar to the term “comprises” as that term is interpreted when employed as a transitional word in a claim.

It will be understood that when a component is referred to as being “connected” or “coupled” to another component, it can be directly connected or coupled or coupled by one or more intervening components unless expressly stated otherwise or the context clearly indicates otherwise.

The term “and/or” includes any and all combinations of one or more of the associated listed items. As used herein, phrases such as “between X and Y” and “between about X and Y” should be interpreted to include X and Y unless expressly stated otherwise or the context clearly indicates otherwise.

Terms such as “about”, “approximately”, and “substantially” are relative terms and indicate that, although two values may not be identical, their difference is such that the apparatus or method still provides the indicated or desired result, or that the operation of a device or method is not adversely affected to the point where it cannot perform its intended purpose. As an example, and not as a limitation, if a height of “approximately X inches” is recited, a lower or higher height is still “approximately X inches” if the desired function can still be performed or the desired result can still be achieved.

While the terms vertical, horizontal, upper, lower, bottom, top, and the like may be used herein, it is to be understood that these terms are used for ease in referencing the drawing and, unless otherwise indicated or required by context, does not denote a required orientation.

The different advantages and benefits disclosed and/or provided by the implementation(s) disclosed herein may be used individually or in combination with one, some or possibly even all of the other benefits. Furthermore, not every implementation, nor every component of an implementation, is necessarily required to obtain, or necessarily required to provide, one or more of the advantages and benefits of the implementation.

Conditional language, such as, among others, “can”, “could”, “might”, or “may”, unless specifically stated otherwise, or otherwise understood within the context as used, is generally intended to convey that certain embodiments preferably or optionally include certain features, elements and/or steps, while some other embodiments optionally do not include those certain features, elements and/or steps. Thus, such conditional language indicates, in general, that those features, elements and/or step may not be required for every implementation or embodiment.

The subject matter described herein is provided by way of illustration only and should not be construed as limiting the nature and scope of the subject invention. While examples of aspects of the subject invention have been provided above, it is not possible to describe every conceivable combination of components or methodologies for implementing the subject invention, and one of ordinary skill in the art may recognize that further combinations and permutations of the subject invention are possible. Furthermore, the subject invention is not necessarily limited to implementations that solve any or all disadvantages which may have been noted in any part of this disclosure. Various modifications and changes may be made to the subject invention described herein without following, or departing from the spirit and scope of, the exemplary embodiments and applications illustrated and described herein. Although the subject matter presented herein has been described in language specific to components used therein, it is to be understood that the subject invention is not necessarily limited to the specific components or characteristics thereof described herein; rather, the specific components and characteristics thereof are disclosed as example forms of implementing the subject invention. Accordingly, the disclosed subject matter is intended to embrace all alterations, modifications, and variations, that fall within the scope and spirit of any claims that are written, or may be written, for the subject invention.

1. A rear tire hitch receiver for coupling with an external rear-mounted spare tire, the rear tire hitch receiver comprising:
a stem including a yoke, the yoke forming a first plurality of lug nut apertures;
a bolt mounting ring secured to the yoke, the bolt mounting ring forming a second plurality of lug nut apertures, wherein at least one of the first plurality of lug nut apertures and at least one of the second plurality of lug nut apertures are in alignment;
each one of the first and second plurality of lug nut apertures being sized and configured for receipt for one of a plurality of lug nuts, wherein each one of the plurality of lug nuts may be removably attached to at least one lug nut receiver of a wheel hub;
a wheel bumper configured to contact a wheel when the rear tire hitch receiver is removably attached to the wheel hub;
a receiver bracket configured to removably couple a receiver to the stem, wherein the receiver is sized and configured to receive and selectively secure a hitch implement to the rear tire hitch receiver;
a hitch pin aperture for secured receipt of a hitch pin; and
a strap guide and a strap attached to the receiver, wherein the strap is sized and configured to be secured around the circumference of the wheel when the rear tire hitch is removably attached to the wheel hub.
